(19) United States
(12) Patent Application Publication
(10) Pub. No.: US 2004/0259674 A1
(43) Pub. Date: Dec. 23, 2004

(54) Sprocket having variable height teeth

(76) Inventor: Dennis M. Pfister, San Luis Obispo, CA (US)

Correspondence Address: Henry C. Query, Jr., 504 S. Pierce Avenue, Wheaton, IL, 60187, US

(21) Appl. No.: 10/872,836

(22) Filed: Jun. 21, 2004

Related U.S. Application Data
(60) Provisional application No. 60/482,125, filed on Jun. 23, 2003.

(51) Int. Cl. F16H 55/30; F16H 55/06

(52) U.S. Cl. 474/152

(57) ABSTRACT

A sprocket for a drive chain comprises a circular hub, a number of drive teeth which extend radially outwardly from the hub, and a plurality of guide teeth which are located between the drive teeth. Each drive tooth has a first height which is sufficient to enable the drive tooth to engage a corresponding pin of the drive chain for the transmission of force therebetween, and each guide tooth has a second height which is smaller that the first height.

This application is based on U.S. Provisional Patent Application No. 60/482,125, which was filed on Jun. 23, 2004.

### BACKGROUND OF THE INVENTION

The present invention relates to a sprocket which is designed to operate with a drive chain. More particularly, the invention relates to a sprocket which includes a number of drive teeth that are sufficiently tall to operatively engage the drive chain and a plurality of guide teeth that are smaller than the drive teeth.

Sprockets are commonly used to transmit power between rotary components, such as the drive shaft of an engine and the axle of a wheel assembly. In such an arrangement, a first sprocket is mounted on the first component, a second sprocket is mounted on the second component, and power is transmitted between the sprockets via a drive chain.

The typical sprocket includes a circular hub which is connected to the component and a plurality of teeth which radiate outwardly from the hub and engage the drive chain. The teeth all have the same height and are usually evenly spaced around the circumference of the hub. Consequently, during rotation of the sprocket all of the teeth operatively engage the drive chain.

However, the engagement of the teeth with the drive chain generates frictional forces which oppose the rotation of the sprocket. These frictional forces thus represent losses in the power which is transmitted between the sprockets. When multiplied by the number of teeth which operatively engage the drive chain, these losses can be significant.

### SUMMARY OF THE INVENTION

In accordance with the present invention, these and other disadvantages in the prior art are overcome by providing a sprocket for a drive chain which includes a number of links that each comprise two side plates which are connected by two pins. In this regard, the sprocket comprises a circular hub, a number of drive teeth which extend radially outwardly from the hub, and a plurality of guide teeth which are located between the drive teeth. Furthermore, each drive tooth has a first height which is sufficient to enable the drive tooth to engage a corresponding pin, and each guide tooth has a second height which is smaller that the first height.

Thus, while the drive teeth are sized to operatively engage the drive chain, the guide teeth do not participate materially in the transmission of force between the sprocket and the drive chain. Consequently, the sprocket is significantly lighter than sprockets which comprise teeth of uniform height. In addition, since the number of drive teeth which engage the drive chain is substantially reduced, the frictional forces between the sprocket and the drive chain will be greatly reduced. Thus, the amount of power lost to these frictional forces is reduced.

These and other objects and advantages of the present invention will be made apparent from the following detailed description, with reference to the accompanying drawings. In the drawings, the same reference numbers are used to denote similar components in the various embodiments.

### BRIEF DESCRIPTION OF THE DRAWINGS

FIG. 1 is a front elevation view of the sprocket of the present invention shown engaged by an exemplary drive chain;

FIG. 2 is an enlarged view of a portion of the sprocket shown in FIG. 1; and

FIG. 3 is a front elevation view of another embodiment of a sprocket of the present invention shown engaged by an exemplary drive chain.

### DETAILED DESCRIPTION OF THE PREFERRED EMBODIMENTS

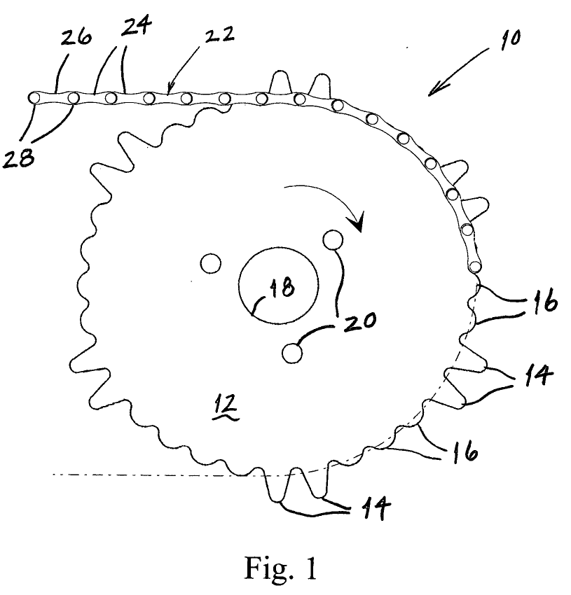

Referring to FIG. 1, the sprocket of the present invention, which is indicated generally by reference number 10, is shown to comprise a circular hub 12, a number of drive teeth 14 which extend radially outwardly from the hub, and preferably a plurality of guide teeth 16 which are located between the drive teeth. The sprocket 10 also ideally includes a central bore 18 and a number of holes 20 for securing the sprocket to a rotary member (not shown).

In FIG. 1, the sprocket 10 is shown in association with an exemplary drive chain 22, which may be, e.g., a conventional roller chain. The drive chain 22 includes a plurality of individual links 24 which are secured together to form a continuous loop. Each link 24 comprises two side plates 26 which are secured together by a pair of pins 28.

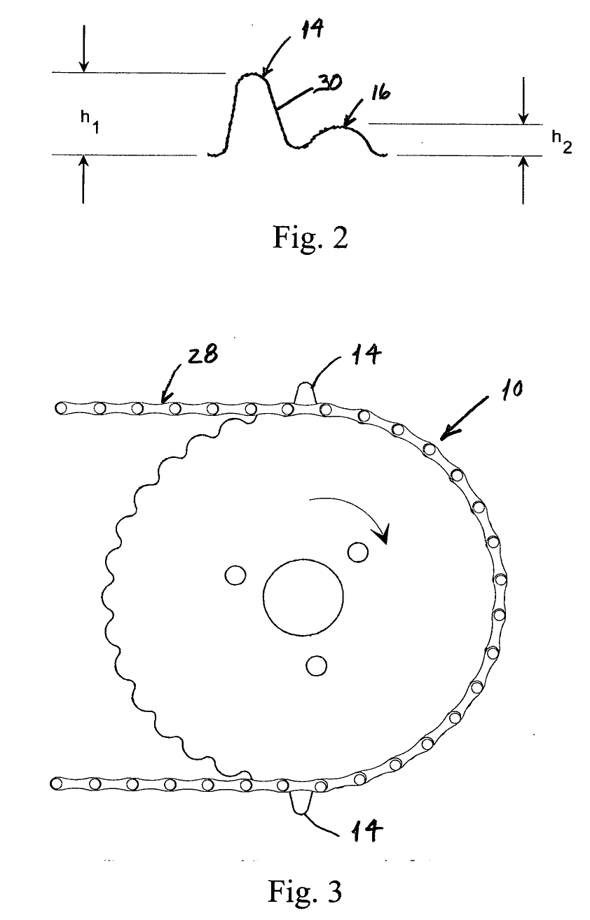

Referring also to FIG. 2, each drive tooth 14 comprises a height h₁ which is sufficient to enable the tooth to operatively engage the drive chain 22. Thus, each drive tooth 14 extends radially outwardly from the hub 12 by an amount h₁ that will enable a face 30 of the drive tooth to engage a corresponding pin 28 in a manner that will allow for the effective transfer of force between the drive tooth and the pin. In this regard it should be noted that, in the Figures, the height of the drive teeth 14 is shown greatly exagerated, and in an operative embodiment of the sprocket 10, the drive teeth 14 will not extend substantially above the pins 28.

Also, in contrast to conventional sprockets, the drive teeth 14 do not extend completely around the hub 12. In this regard, the inventor has discovered that force can be effectively transmitted between a sprocket and a drive chain by a single tooth. Thus, depending on the degree of wrap of the drive chain around the sprocket, only a few teeth may be required to effectively transmit the force to or from the drive chain during each revolution of the sprocket.

In accordance with the present invention, therefore, the drive teeth 14 are positioned at predetermined, though not necessarily regular, intervals around the hub 12. For example, in the embodiment of the invention shown in FIG. 1, pairs of drive teeth 14 are located at approximately 30°, 85°, 140°, 210°, 280° and 335° around the hub 12. In this regard, the drive teeth 14 are positioned in pairs to reduce the amount of slippage between the drive chain 28 and the sprocket 10. In the embodiment of the invention shown in FIG. 3, however, single drive teeth 14 are positioned at approximately 90° and 270° around the hub 12.

As shown in FIGS. 1 and 3, the guide teeth 16 extend radially outwardly from the hub 12 between the drive teeth 14. Since the drive teeth 14 function to transmit substantially all the force between the sprocket 10 and the drive chain 28, the guide teeth 16 need not have the same height as the drive teeth. Rather, the guide teeth 16 are preferably only sufficiently tall to engage at least part of the side plates 26 of the links 24. In this manner, the guide teeth 16 will aid in retaining the drive chain 28 on the sprocket 10, but will not participate materially in the transmission of force between the sprocket and the drive chain. As shown in FIG. 2, each guide tooth 16 has a height h₂ which is substantially smaller than the height h₁ of the drive teeth 14. Preferably, the height h₂ of each guide tooth 16 is less than one-half the height h₁ of the drive teeth 14. More preferably, the height h₂ is approximately one-third the height h₁. Furthermore, the guide teeth 16 need not all have the same height h₂ or the same geometry.

Thus, it may be seen that the sprocket 10 of the present invention comprises a relatively small number of drive teeth 14 which are separated by a plurality of guide teeth 16. In addition, while the drive teeth 14 are sized to operatively engage the drive chain 28, the guide teeth 16 are designed to be smaller than the drive teeth so that they do not participate materially in the transmission of force between the sprocket 10 and the drive chain. Consequently, the sprocket 10 is significantly lighter than sprockets which comprise teeth of uniform height. In addition, since the number of drive teeth 14 which engage the drive chain 28 is substantially reduced, the frictional forces between the sprocket 10 and the drive chain 28 will be greatly reduced. Thus, the amount of power lost to these frictional forces is reduced.

It should be recognized that, while the present invention has been described in relation to the preferred embodiments thereof, those skilled in the art may develop a wide variation of structural and operational details without departing from the principles of the invention. For example, the various elements shown in the different embodiments may be combined in a manner not illustrated above. Therefore, the appended claims should be construed to cover all equivalents falling within the true scope and spirit of the invention.

I claim:

1. A sprocket for a drive chain which includes a number of links that each comprise two side plates which are connected by two pins, the sprocket comprising:
a circular hub;
a number of drive teeth which extend radially outwardly from the hub; and
a plurality of guide teeth which are located between the drive teeth;
wherein each drive tooth has a first height which is sufficient to enable the drive tooth to engage a corresponding pin; and
wherein each guide tooth has a second height which is smaller that the first height.

2. The sprocket of claim 1, wherein the second height is sufficient to enable the guide teeth to engage at least part of the side plates.

3. The sprocket of claim 1, wherein the second height is less than one-half the first height.

4. The sprocket of claim 1, wherein the second height is approximately one-third the first height.

5. The sprocket of claim 1, wherein the sprocket comprises a plurality of pairs of adjacent drive teeth and the guide teeth are located between the pairs of drive teeth.

6. The sprocket of claim 5, wherein the pairs of drive teeth are located at approximately 30°, 85°, 140°, 210°, 280° and 335° around the circumference of the hub 12.

7. The sprocket of claim 1, wherein the sprocket comprises two drive teeth which are positioned at approximately 90° and 270° around the circumference of the hub.
